(19) United States
(12) Patent Application Publication
(10) Pub. No.: US 2002/0037803 A1
(43) Pub. Date: Mar. 28, 2002

(54) Silicon nitride sintered body, silicon nitride ball, silicon nitride bearing ball, ball bearing, motor having bearing, hard disk drive, and polygon scanner

(75) Inventors: Tomonori Niwa, Aichi (JP); Tetsuji Yogo, Aichi (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: NGK SPARK PLUG CO., LTD.

(21) Appl. No.: 09/908,661

(22) Filed: Jul. 20, 2001

(30) Foreign Application Priority Data
Jul. 21, 2000 (JP) 2000-221370

(51) Int. Cl. C04B 35/584

(52) U.S. Cl. 501/97.1

(57) ABSTRACT

A silicon nitride sintered body, e.g., a ball, exhibiting excellent machinability is disclosed, having an X-ray diffraction profile measured on a cross section of the silicon nitride sintered body by means of a diffractometer such that Xβ/(Xα+Xβ) is 0.9−1, wherein Xα is the highest peak intensity associated with a silicon nitride phase and Xβ is the highest peak intensity associated with β silicon nitride phase, and silicon nitride grains of said body have an average grain size dav of 0.5-5.0 μm and a grain aspect ratio α of 1-5, and are present in an average number of not less than 2×10⁴ per square millimeter in a predominant crystalline phase observed on the cross section.

### FIELD OF THE INVENTION

The present invention relates to a silicon nitride sintered body, a silicon nitride ball, a silicon nitride bearing ball, a ball bearing, a motor having the bearing, a hard disk drive, and a polygon scanner.

### BACKGROUND OF THE INVENTION

Silicon nitride ceramic is light as compared with metallic materials, exhibits excellent heat resistance and wear resistance, and, as compared with other ceramic materials, exhibits good balance between mechanical strength and toughness. Thus, silicon nitride ceramic is widely used as material for structural components, such as sliding members, cutting tools, and bearing balls.

Conventionally, silicon nitride ceramic has been improved mostly in terms of enhancement of wear resistance and high-temperature strength. Accordingly, toughness is sacrificed for enhancement of strength, and high strength causes difficulty in machining. However, in certain applications, such as use at room temperature under relatively low load, silicon nitride ceramic is not necessarily expected to exhibit good high-temperature strength. For example, in application to rotating or sliding members of electric products and computer equipment, silicon nitride ceramic is not expected to exhibit good high-temperature strength. However, in actuality, unnecessarily high strength is imparted to silicon nitride ceramic for such applications, resulting in poor machinability and thus increased manufacturing cost. In this way, manufacture of silicon nitride ceramic products has involved unbalanced material design.

An object of the present invention is to provide a silicon nitride sintered body exhibiting excellent machinability while maintaining appropriate mechanical strength and wear resistance, a silicon nitride ball formed from the silicon nitride sintered body, a silicon nitride bearing ball formed from the silicon nitride ball, a ball bearing using the silicon nitride bearing ball, a motor having a bearing using the ball bearing, a hard disk drive using the motor, and a polygon scanner using the motor.

### SUMMARY OF THE INVENTION

To achieve the above object, the present invention provides a silicon nitride sintered body whose predominant crystalline phase is a silicon nitride phase, wherein

an X-ray diffraction profile measured on a cross section of said body by means of a diffractometer is such that Xβ/(Xα+Xβ) is 0.9−1, wherein Xα is a peak intensity associated with α silicon nitride phase and Xβ is a peak intensity associated with β silicon nitride phase, and

silicon nitride phase crystal grains of said body have an average grain size dav represented by (dmax+dmin)/2 of 0.5-5.0 μm and a grain aspect ratio α represented by dmax/dmin of 1-5, and are present in an average number of not less than 2×10⁴ per square millimeter at least in a region on the cross section ranging from a surface of the sintered body to a depth of 0.5 mm, wherein dmax is a distance between parallel lines circumscribing an outline of an observed silicon nitride phase crystal grain and whose distance is the greatest among such circumscribing parallel lines, and dmin is a distance between parallel lines circumscribing the outline of the observed silicon nitride phase crystal grain and whose distance is the shortest among such circumscribing parallel lines.

The present invention also provides a silicon nitride ball whose predominant crystalline phase is a silicon nitride phase, wherein

an X-ray diffraction profile measured on a cross section taken substantially across a center of the ball by means of a diffractometer is such that Xβ/(Xα+Xβ) is 0.9−1, wherein Xα is a peak intensity associated with α silicon nitride phase and Xβ is a peak intensity associated with β silicon nitride phase, and

silicon nitride phase crystal grains of said body have an average grain size dav represented by (dmax+dmin)/2 of 0.5-5.0 μm and grain aspect ratio α represented by dmax/dmin of 1-5, and are present in an average number of not less than 2×10⁴ per square millimeter at least in a region on the cross section ranging from a surface of the sintered body to a depth of 0.5 mm, wherein dmax is a distance between parallel lines circumscribing an outline of an observed silicon nitride phase crystal grain and whose distance is the greatest among such circumscribing parallel lines, and dmin is a distance between parallel lines circumscribing the outline of the observed silicon nitride phase crystal grain and whose distance is the shortest among such circumscribing parallel lines. Herein, the term “predominant crystalline phase” means a crystalline phase that makes up a largest portion of microstructure.

### BRIEF DESCRIPTION OF THE DRAWINGS

FIG. 1 is a view showing the definition of the average grain size dav and the grain aspect ratio α of a crystal grain.

FIG. 2 is a longitudinal sectional view showing an example of apparatus for manufacturing forming material powder.

FIG. 3 is a view showing the action of the apparatus of FIG. 2.

FIG. 4 is a view showing an action subsequent to that of FIG. 3.

FIG. 5 is a view showing a step of rolling granulation.

FIG. 6 is a view showing a step of rolling granulation subsequent to the step of FIG. 5.

FIGS. 7(a)-(e) are views showing a rolling granulation process, depicting the progress of rolling granulation.

FIG. 8 is a schematic view showing the cross-sectional structure of a spherical ceramic sintered body manufactured by rolling granulation.

FIG. 9 is a view showing the concept of the diameter of a primary particle and the diameter of a secondary particle.

FIGS. 10(a) and (b) are sectional views showing examples of a method for manufacturing a green body through die pressing.

FIGS. 11(a) and (b) are views showing the concept of cumulative relative frequency.

FIG. 12 is a schematic view showing a ball bearing incorporating silicon nitride ceramic balls of the present invention.

FIG. 13 is a longitudinal sectional view showing an example of a hard disk drive for computer use incorporating a ball bearing of FIG. 12.

FIG. 14 is an image showing the cross section of a silicon nitride ball of the present invention as observed through an SEM.

FIGS. 15(a)-(e) show views of several examples of a forming nucleus.

FIGS. 16(a)-(e) show views of several examples of a method for manufacturing a forming nucleus.

FIG. 17 is a view showing an example of an X-ray diffraction profile as observed on the cross section of a silicon nitride ball of the present invention.

FIG. 18 is a sectional view showing an example of a hard disk drive equipped with a head arm drive mechanism.

FIGS. 19(a)-(c) are sectional views showing an example of a polygon scanner using the ball bearing of FIG. 12.

### DETAILED DESCRIPTION OF THE INVENTION

The inventors of the present invention have found that, through attainment of an X-ray diffraction profile such that the peak intensity ratio, Xβ/(Xα+Xβ), is 0.9−1, wherein Xα is a peak intensity associated with α silicon nitride phase and Xβ is a peak intensity associated with β silicon nitride phase; i.e., through employment of the phase configuration that the β silicon nitride phase is predominant to such an extent as to attain the peak intensity ratio, and through adjustment of microstructure such that silicon nitride phase crystal grains each having a grain aspect ratio α of 1-5 are present in an average number of not less than 2×10⁴ per square millimeter, there can be realized a silicon nitride sintered body or a silicon nitride ball exhibiting excellent machinability and having mechanical strength and wear resistance that are not unnecessarily high. Thus is achieved in the present invention.

When the content of α silicon nitride grains, which exhibit high hardness, increases excessively in the material, the material becomes excessively hard, resulting in impaired machinability. Studies conducted by the present inventors revealed that even in the case of employment of a microstructure such that, through reduction of a silicon nitride grains to the greatest possible extent, the β silicon nitride phase predominates to such an extent that a ratio Xβ/(Xα+Xβ) is not less than 0.9, mechanical strength and wear resistance of a sintered body are not impaired to a great extent and can be maintained at sufficiently high level unless the sintered body is used, for example, at excessively high temperature, and machinability of the sintered body is improved significantly as a result of elimination of hard α silicon nitride grains.

The present inventors studied further while focusing attention on the aspect ratio α of silicon nitride crystal grains as observed on the cross section of a sintered body, and found the following. When crystal grains each having an average grain size dav of 0.5-5.0 μm and an aspect ratio α of 1-5 indicative of relatively low profile directivity are present in an average number of 2×10⁴ per square millimeter on the cross section, machining, such as cutting and polishing, of a sintered body is facilitated, thereby enabling efficient manufacture of a silicon nitride sintered body or a silicon nitride ball having sufficiently high mechanical strength and wear resistance.

The above-mentioned silicon nitride balls of the present invention can be effectively used as rolling elements of a bearing; for example, as bearing balls of a bearing used in a rotary drive unit of precision equipment, such as peripheral equipment of a computer—a hard disk drive (hereinafter called an HDD), a CD-ROM drive, an MO drive, or a DVD drive—or a polygon scanner of a laser printer. A bearing used in a rotary drive unit of such precision equipment must rotate at a high speed of, for example, not less 8000 rpm (in some cases not less than 10000 rpm or not less than 30000 rpm). Silicon nitride ceramic having excellent wear resistance can be effectively used as material for bearing balls to be used in such a condition of high-speed rotation. With a recent explosive increase in production of peripheral equipment of a computer, such as laser printers and hard disk drives, there has been eager demand for technology for manufacturing small high-performance ceramic balls for bearings at high efficiency. The present invention enhances efficiency of machining, such as precision polishing, which is a determinant of the rate of manufacture of bearing balls, thereby enabling low-cost, efficient supply of high-performance bearing balls for use in a bearing of a hard disk drive or a polygon scanner.

The present invention also provides a ball bearing in which a plurality of silicon nitride bearing balls mentioned above are incorporated as rolling elements. For example, such a ball bearing can be used in a hard disk drive as a bearing member for a shaft for rotating a hard disk, or as a bearing member for a rotary shaft for driving a head arm or can be used as a bearing member for a rotary shaft for rotating a polygon mirror of a polygon scanner to be used in, for example, a laser printer. The present invention further provides a motor having a bearing in which the ball bearing mentioned above is used as a bearing member. The present invention still further provides a hard disk drive comprising the motor having a bearing mentioned above and a hard disk rotatable by the motor as well as a polygon scanner comprising the motor having a bearing mentioned above and a polygon mirror rotatable by the motor.

Silicon nitride ceramic from which the sintered body or bearing ball of the present invention is formed contains a predominant amount of silicon nitride (Si₃N₄) and a balance of a sintering aid component. Such a sintering aid component may be at least one element selected from the group consisting of Mg and elements belonging to Groups 3A, 4A, 5A, 3B (e.g., Al (in the form of, for example, alumina)), and 4B (e.g., Si (in the form of, for example, silica)) of the Periodic Table, and may be contained in an amount of 1-15% by weight on an oxide basis. These elements are present within a sintered body mainly in the form of respective oxides.

When the sintering aid component content is less than 1% by weight, a sintered body is unlikely to become dense. When the sintering aid component content is in excess of 15% by weight, a sintered body suffers lack of strength, toughness, or heat resistance, and a sintered body serving as a sliding component suffers an impairment in wear resistance. Preferably, the sintering aid component is contained in an amount of 1-10% by weight. Notably, in the present invention, unless otherwise specified, the term “predominant” used in relation to content means that a substance in question is contained in an amount of not less than 50% by weight (the terms “predominantly” and “mainly” have the same meaning).

Examples of elements found in commonly used sintering aid components and belonging to Group 3A include Sc, Y, La, Ce, Pr, Nd, Sm, Eu, Gd, Tb, Dy, Ho, Er, Tm, Yb, and Lu. The content of each of these elements R is expressed on an oxide basis; specifically, on the basis of RO₂ for Ce and on the basis of R₂O₃ for the remaining elements. Particularly, oxides of heavy-rare-earth elements Y, Tb, Dy, Ho, Er, Tm, and Yb are used favorably, since they have the effect of improving strength, toughness, and wear resistance of a silicon nitride sintered body. Also, magnesia spinel and zirconia can be used as sintering aids.

The microstructure of the silicon nitride sintered body of the present invention is such that portions of the silicon nitride predominant crystalline phase are bonded by means of a glassy and/or crystalline bond phase. In this case, the silicon nitride phase serving as the predominant crystalline phase may comprise not only silicon nitride (Si₃N₄) but also Si₃N₄ having a portion of Si or N atoms substituted by Al or oxygen atoms, as well as metallic atoms, such as Li, Ca, Mg, and Y, present in the form of solid solution. Examples of silicon nitride which has undergone such substitution include sialons represented by the following formulas.

β-sialon: Si_{6-z}Al_{z}O_{z}N_{8-z}(z=0 to 4.2)

α-sialon: Mₓ(Si,Al)₁₂(O,N)₁₆(x=0 to 2)

M: Li, Mg, Ca, Y, R (R represents rare-earth elements excluding La and Ce)

The aforementioned sintering aid component mainly constitutes the bond phase, but a portion of the sintering aid component may be incorporated into the predominant crystalline phase. The bond phase may contain, in addition to intentionally added components serving as sintering aids, unavoidable impurities; for example, silicon oxide contained in a material silicon nitride powder.

A sintered body whose predominant crystalline phase is the β silicon nitride phase exhibits machinability higher than that of a sintered body whose predominant crystalline phase is the α silicon nitride phase. Since α silicon nitride is higher in hardness than β silicon nitride, a sintered body whose predominant crystalline phase is the α silicon nitride phase encounters difficulty in machining. The ratio between the α silicon nitride phase and the β silicon nitride phase in a sintered body can be determined from the aforementioned peak intensity ratio Xβ/(Xα+Xβ) to be obtained from an X-ray diffraction profile measured on a cross section of the sintered body by means of a diffractometer. A peak intensity ratio Xβ/(Xα+Xβ) of 0.9−1 enhances machinability of a sintered body.

Diffraction peaks can be measured in the following manner. A diffraction profile is measured by means of a diffractometer using the Kα ray (wavelength: approx. 1.5405 angstroms) of Cu as an incident X ray (tube voltage: 50 kV; and tube current: 100 mA). According to the diffraction data cards of the American Society of Testing & Materials (ASTM), for α silicon nitride, the (102) peak emerging at interplanar spacing d=2.599 angstroms and diffraction angle 2θ=34.5° (hereinafter the intensity of the peak is expressed as Iα(102)) is of the highest intensity, and the (210) peak emerging at interplanar spacing d=2.547 angstroms and diffraction angle 2θ=35.2° (hereinafter the intensity of the peak is expressed as Iα(210)) is of the second highest intensity. For β silicon nitride, the (101) peak emerging at interplanar spacing d=2.668 angstroms and diffraction angle 2θ=33.6° (hereinafter the intensity of the peak is expressed as Iβ(101)) and the (210) peak emerging at interplanar spacing d=2.492 angstroms and diffraction angle 2θ=36.0° (hereinafter the intensity of the peak is expressed as Iβ(210)) are diffraction peaks of substantially equal intensity, which is the highest intensity. Herein, a peak intensity associated with the α silicon nitride phase is defined as

Xα=(Iα(102)+Iα(210))/2

A peak intensity associated with the β silicon nitride phase is defined as

Xβ=(Iβ(101)+Iβ(210))/2

Notably, a peak position associated with each lattice plane may deviate, for example, approximately ±0.3° from a peak position specified on the relevant card due to various causes, such as presence of solid solution atoms and thermal stress.

A peak intensity ratio Xβ/(Xα+Xβ) of 1 means that the Xα value is 0; i.e., the content of the a silicon nitride phase is lower than the detection threshold of X-ray diffraction. By contrast, when a peak intensity ratio Xβ/(Xα+Xβ) is less than 0.9, the α silicon nitride phase content increases, causing poor machinability of a sintered body. In view of enhanced machinability, the peak intensity ratio Xβ/(Xα+Xβ) is preferably 0.95-1, more preferably 1.

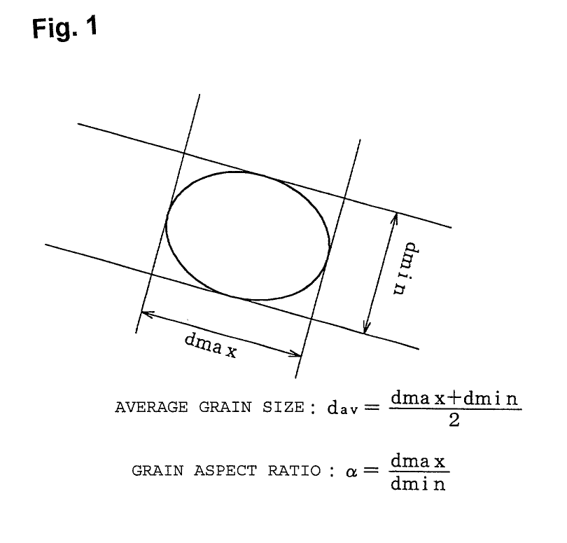

An important factor for improving machinability of ceramic is that silicon nitride phase crystal grains each having an average grain size dav of 0.5-5.0 μm and a grain aspect ratio α of 1-5 be present in an average number of not less than 2×10⁴ per square millimeter at least in a region of a sintered body related to machining; specifically, at least in a region ranging from the surface of the sintered body to a depth of 0.5 mm. Definitions of the average grain size dav and the grain aspect ratio α are described below with reference to FIG. 1. The average grain size dav is defined as (dmax+dmin)/2, and the grain aspect ratio α is defined as dmax/dmin, wherein dmax is the distance between parallel lines circumscribing the outline of a silicon nitride phase crystal grain observed on the cross section of ceramic and whose distance is the greatest among such circumscribing parallel lines, and dmin is the distance between parallel lines circumscribing the outline of the observed silicon nitride phase crystal grain and whose distance is the shortest among such circumscribing parallel lines.

A grain having an average grain size dav of less than 1 μm is too small and hardly contributes to improvement of machinability even when the grain aspect ratio α falls within the above-mentioned range. A grain having a dav value of not less than 10 μm is too large and may cause impairment in strength. Since dmax is greater than dmin, the grain aspect ration α (=dmax/dmin) is never less than 1. A grain having an α value in excess of 5 assumes an acicular form. Improvement of machinability cannot be expected from a sintered body whose microstructure consists of such acicular grains. The present invention allows the presence of grains having α values in excess of 5. However, an important factor for improving the machinability of silicon nitride ceramic while maintaining appropriate mechanical strength and wear resistance is that grains having α values of 1-5 be present in a number of not less than 2×10⁴ per square millimeter as observed on the cross section of a sintered body. When grains having α values of 1-5 are present in a number of less than 2×10⁴ per square millimeter, improvement of machinability becomes difficult. The present invention does not preclude the case where all grains have α values of 1-5.

The average grain size dav, the grain aspect ratio α, and the number of grains are measured in the following manner. The cross section of a sintered body is observed by means of, for example, a scanning electron microscope (SEM). On the basis of an obtained image of observation, the average grain size dav and the grain aspect ratio α are obtained according to the aforementioned method, and the number of grains within a predetermined area is counted. The counted number of grains is converted to the number of grains per square millimeter. An appropriate size for field of observation is, for example, 50 μm×50 μm. When accurate values are to be obtained, the number of fields of observation may preferably be increased to 5 or more.

Various embodiments of the present invention are described below.

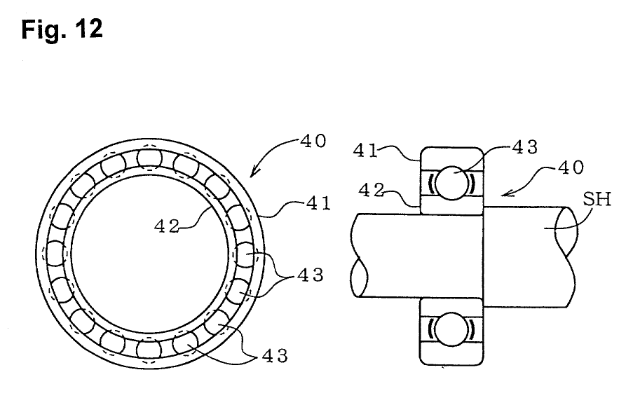

FIG. 12 shows a ball bearing 40 configured such that bearing balls 43 according to an embodiment of a silicon nitride sintered body of the present invention are incorporated between an inner ring 42 and an outer ring 41, which are made of metal or ceramic. When a shaft SH is fixedly attached to the internal surface of the inner ring 42 of the ball bearing 40, the bearing balls 43 are supported rotatably or slidably with respect to the outer ring 41 or the inner ring 42. As described previously, the bearing ball 43 is formed from silicon nitride ceramic contains silicon nitride as a predominant component, and a sintering aid component, wherein an X-ray diffraction profile measured on a cross section thereof by means of a diffractometer is such that Xβ/(Xα+Xβ) is 0.9-1, wherein Xα is the highest peak intensity associated with α silicon nitride phase and Xβ is the highest peak intensity associated with β silicon nitride phase, and silicon nitride phase crystal grains of said body have an average grain size dav represented by (dmax+dmin)/2 of 0.5-5.0 μm and a grain aspect ratio a represented by dmax/dmin of 1-5, and are present in an average number of not less than 2×10⁴ per square millimeter at least in a region on the cross section ranging from the surface of the sintered body to a depth of 0.5 mm, wherein dmax is the distance between parallel lines circumscribing the outline of an observed silicon nitride phase crystal grain and whose distance is the greatest among such circumscribing parallel lines, and dmin is the distance between parallel lines circumscribing the outline of the observed silicon nitride phase crystal grain and whose distance is the shortest among such circumscribing parallel lines.

Another embodiment of the present invention is described with reference to the method for manufacturing the silicon nitride ceramic ball mentioned above. Preferably, a silicon nitride powder serving as material is such that the a phase makes up not less than 90% the predominant crystalline phase thereof. To the silicon nitride powder, at least one element selected from the group consisting of rare-earth elements and elements belonging to Groups 3A, 4A, 5A, 3B, and 4B is added as a sintering aid in an amount of 1-15% by weight, preferably 1-10% by weight, on an oxide basis. Notably, in preparation of the material, these elements may be added in the form of not only oxide but also a compound to be converted to oxide in the course of sintering, such as carbonate or hydroxide.

In order to be compatible with the rolling granulation process to be described later, a forming material powder preferably has an average grain size of 0.3-2 μm and a 90% grain size of 0.7-3.5 μm as measured by use of a laser diffraction granulometer and a BET specific surface area of 5-13 m²/g. These preferences are not applicable when a forming process other than the rolling granulation process is employed.

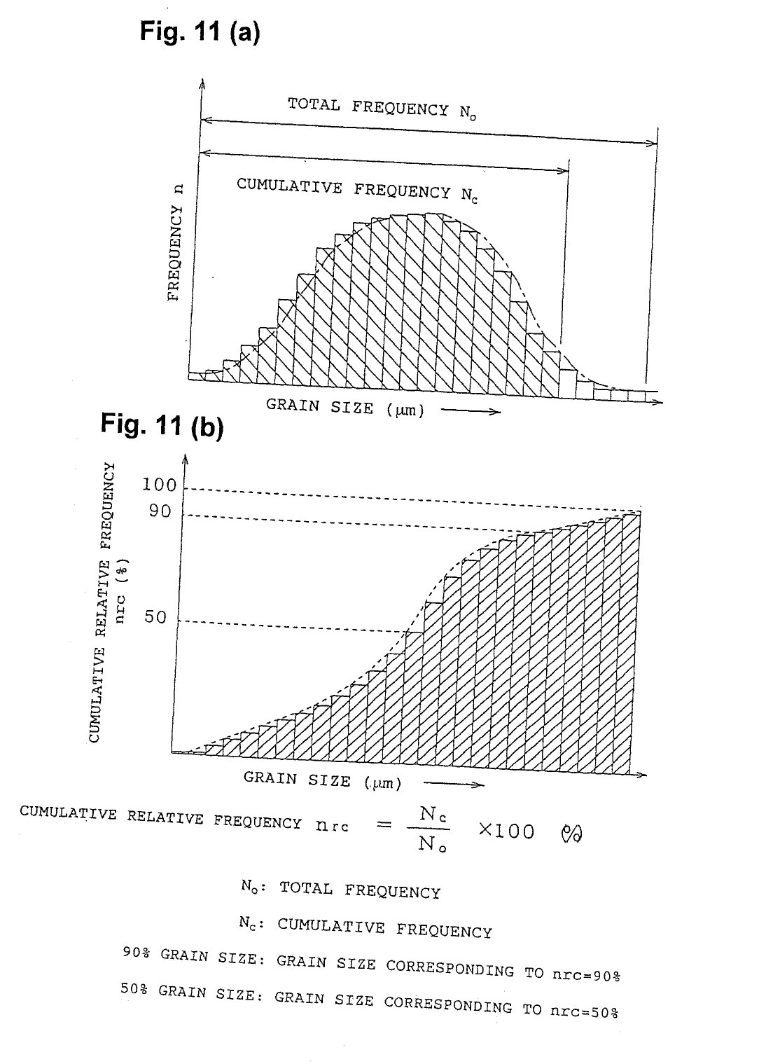

The grain size measured by means of a laser diffraction granulometer reflects the diameter of a secondary particle D shown in FIG. 9. The cumulative relative frequency with respect to grain size as measured in the ascending order of grain size is defined in the following manner. As shown in FIG. 11, frequencies of grain sizes of particles to be evaluated are distributed in the ascending order of grain size. In the cumulative frequency distribution of FIG. 11, Nc represents the cumulative frequency of grain sizes up to the grain size in question, and N0 represents the total frequency of grain sizes of particles to be evaluated. The relative frequency nrc is defined as “(Nc/N0)×100(%).” The X% grain size refers to a grain size corresponding to nrc=X (%) in the distribution of FIG. 12. For example, the 90% grain size is a grain size corresponding to nrc=90(%).

The specific surface area of the forming material powder is measured by the adsorption method. Specifically, the specific surface area can be obtained from the amount of gas adsorbed on the surface of powder particles. According to general practice, an adsorption curve indicative of the relationship between the pressure of gas to be measured and the amount of adsorption is obtained through measurement. The known BET (an acronym representing originators, Brunauer, Emett, and Teller) formula related to polymolecular adsorption is applied to the adsorption curve so as to obtain the amount of adsorption vm upon completion of a monomolecular layer. A BET specific surface area calculated from the obtained amount of adsorption vm is used as the specific surface area of the powder. However, when approximation does not make much difference, the amount of adsorption vm of the monomolecular layer may be read directly from the adsorption curve. For example, when the adsorption curve contains a section in which the pressure of gas is substantially proportional to the amount of adsorption, the amount of adsorption corresponding to the low-pressure end point of the section may be read as the vm value (refer to the monograph by Brunauer and Emett appearing in The Journal of American Chemical Society, Vol. 57 (1935), page 1754). Since molecules of adsorbed gas penetrate into a secondary particle to thereby cover individual constituent primary particles of the secondary particle, the specific surface area obtained by the adsorption method reflects the specific surface area of a primary particle and thus reflects the average value of the diameter of a primary particle d shown in FIG. 9.

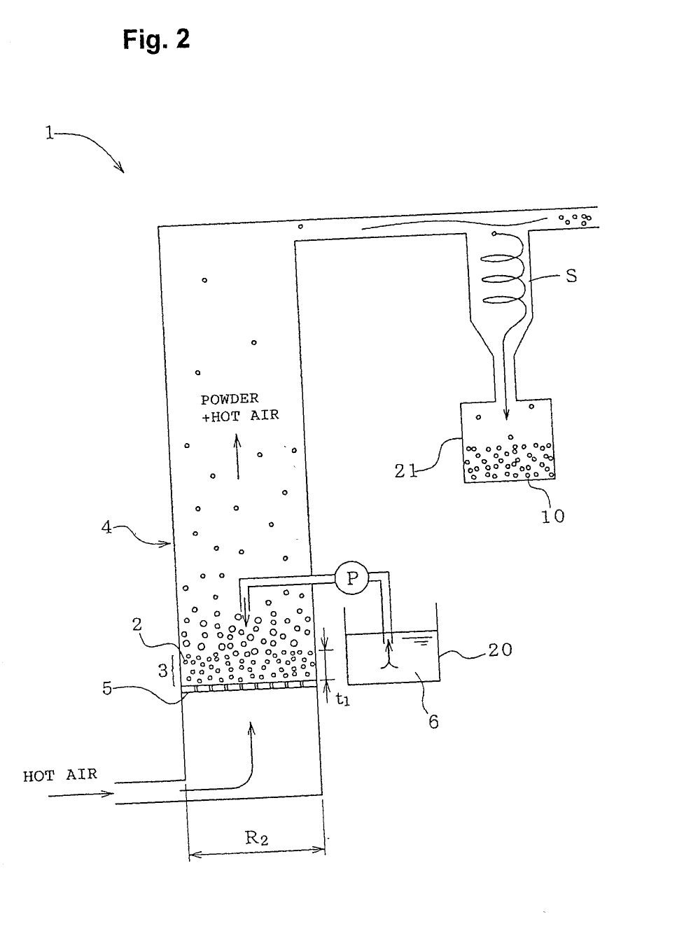

A method for preparing a forming material powder and a method for forming a green body from the forming material powder will be described. FIG. 2 shows an embodiment of an apparatus used in a process for preparing the forming material powder. In the apparatus, a hot air passage 1 includes a vertically disposed hot air duct 4. The hot air duct 4 includes a drying-media holder 5, which is located at an intermediate position of the hot air duct 4 and which includes a gas pass body, such as mesh or a plate having through-holes formed therein, adapted to permit passage of hot air and adapted not to permit passage of drying media 2. The drying media 2 are each composed of a ceramic ball, which is formed predominantly of alumina, zirconia, or a mixture thereof. The drying media 2 aggregate on the drying-media holder 5 to form a layer of drying-media aggregate 3.

Material is prepared in the form of a slurry 6 in the following manner. To the mixture of a silicon nitride powder and a sintering aid powder, an aqueous solvent is added. The resultant mixture is wet-mixed (or wet-mixed and pulverized) by use of a ball mill or an attriter, thereby yielding the slurry 6. In this case, the size of a primary particle is adjusted such that the BET specific surface area becomes 5-13 m²/g.

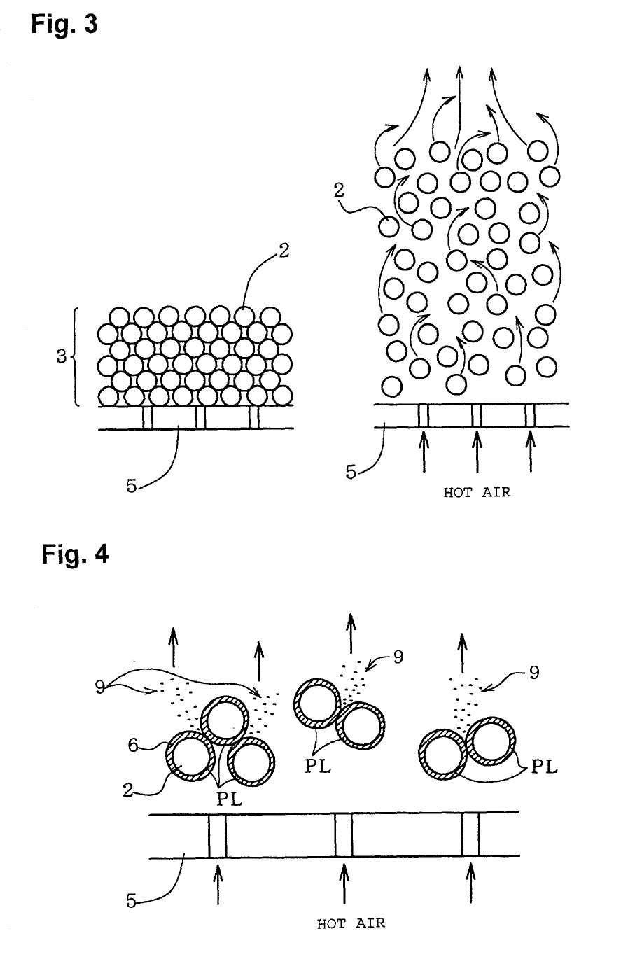

As shown in FIG. 3, hot air is caused to flow through the drying-media aggregate 3 from underneath the drying-media holder 5 and to flow upward through the hot air duct 4 while agitating the drying media 2. As shown in FIG. 2, a pump P pumps up a slurry 6 from a slurry tank 20. The slurry 6 is fed to the drying-media aggregate 3 from above and through effect of gravity. As shown in FIG. 4, the slurry 6 adheres to the surfaces of the drying media 2 while being dried by hot air, thereby forming a powder aggregate layer PL on the surface of each drying medium 2.

The flow of hot air causes repeated agitation and fall of the drying media 2. Thus, the individual pieces of drying media 2 collide and rub against one another, whereby the powder aggregate layers PL are pulverized into forming material powder particles 9. Some of the forming material powder particles 9 assume the form of a solitary primary particle, but most of the forming material powder particles 9 assume the form of a secondary particle, which is the aggregation of primary particles. The forming material powder particles 9 having a grain size not greater than a certain value are conveyed downstream by hot air (FIG. 2). The forming material powder particles 9 having a grain size greater than a certain value are not blown by hot air, but again fall onto the drying-media aggregate 3, thereby undergoing further pulverization effected by the drying media 2. The forming material powder particles 9 conveyed downstream by hot air pass through a cyclone S and are then collected as forming material powder 10 in a collector 21.

In FIG. 2, the diameter of the drying medium 2 is determined as appropriate according to the cross-sectional area of the hot air duct 4. If the diameter of the drying medium 2 is insufficient, a sufficiently large impact force will not be exerted on the powder aggregate layers PL formed on the drying media 2. As a result, the forming material powder 10 may fail to have a predetermined grain size. If the diameter of the drying medium 2 is excessively large, the flow of hot air will encounter difficulty in agitating the drying media 2, again causing poor impact force. As a result, the forming material powder 10 may fail to have a predetermined grain size. Preferably, the drying media 2 are substantially uniform in diameter so as to leave an appropriate space thereamong, whereby the motion of the drying media 2 is accelerated during flow of hot air.

A thickness t1 of the drying media 2 of the drying-media aggregate 3 is determined such that the drying media 2 move appropriately according to the velocity of hot air. If the thickness t1 is excessively large, the drying media 2 will encounter difficulty in moving, causing poor impact force. As a result, the forming material powder 10 may fail to have a predetermined grain size. If the thickness t1; i.e., the amount of the drying media 2, is excessively small, the drying media 2 will collide less frequently, resulting in impaired processing efficiency.

The temperature of hot air is determined such that the slurry 6 is dried sufficiently and the forming material powder 10 does not suffer any problem, such as thermal deterioration. For example, when a solvent used for preparation of the slurry 6 is composed predominantly of water, hot air having a temperature lower than 100° C. fails to sufficiently dry the fed slurry 6. The resultant forming material powder 10 has an excessively high water content and thus tends to agglomerate. As a result, the forming material powder 10 may fail to have a predetermined grain size. The velocity of hot air is determined so as not to cause the drying media 2 to fly into the collector 21. If the velocity is excessively low, the drying media 2 will encounter difficulty in moving, resulting in poor impact force. As a result, the forming material powder 10 may fail to have a predetermined grain size. If the velocity is excessively high, the drying media 2 will fly too high, causing reduced frequency of collision. As a result, processing efficiency will decrease.

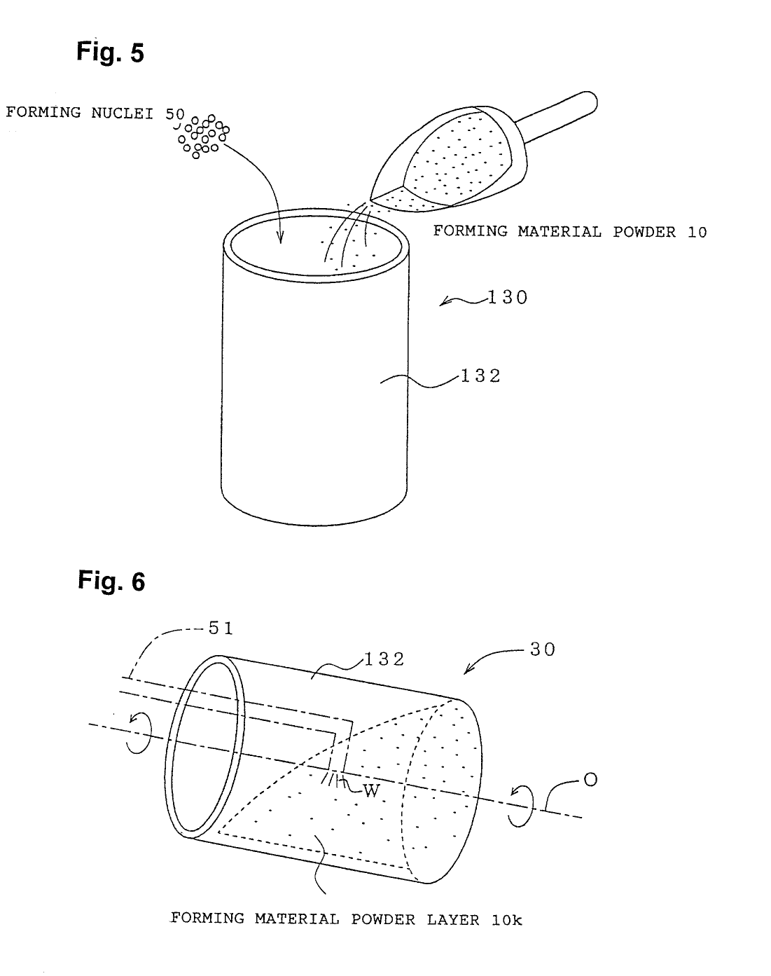

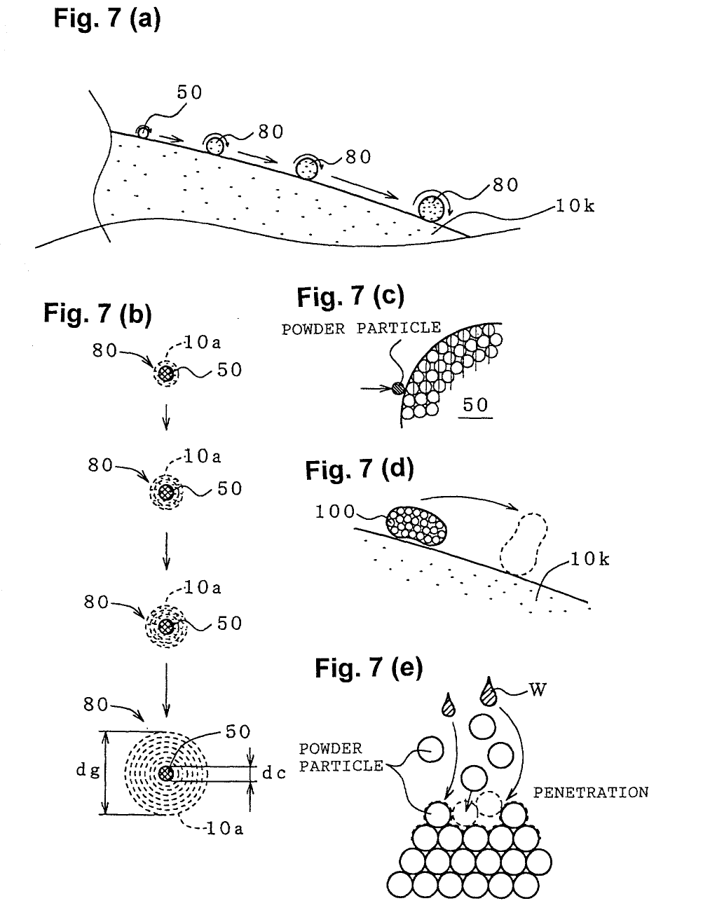

The thus-obtained forming material powder 10 can be formed into spherical bodies by means of the rolling granulation process. Specifically, as shown in FIG. 5, the forming material powder 10 is placed in a granulation container 132. As shown in FIG. 6, the granulation container 132 is rotated at a constant peripheral speed. Water W is fed to the forming material powder 10 contained in the granulation container 132, through, for example, spraying. As shown in FIG. 7, the charged forming material powder 10 rolls down an inclined powder layer 10k formed in the rotating granulation container 132 to thereby spherically aggregate into a green body 80. The operating conditions of a rolling granulation apparatus 30 are adjusted such that the obtained green body 80 assumes a relative density of not lower than 61%. Specifically, the rotational speed of the granulation container 132 is adjusted to 10-200 rpm. The water feed rate is adjusted such that the finally obtained green body 80 assumes a water content of 10-20% by weight. As shown in FIG. 7(e), as a result of feed of water, water penetrates into intergranular spaces to thereby further densify a green body.

Through employment of rolling granulation described above, highly dense, spherical green bodies each having a diameter of, for example, up to approximately 10 mm can be manufactured at very high efficiency. In the case of a small-diameter green body such that the ratio between surface area A′ and weight W′, A′/W′, is not less than 350 (for example, the diameter is not greater than 6.73 mm), the green body can assume a density level of approximately 2.0-2.5 g/cm³, which cannot be attained by an ordinary pressing process.

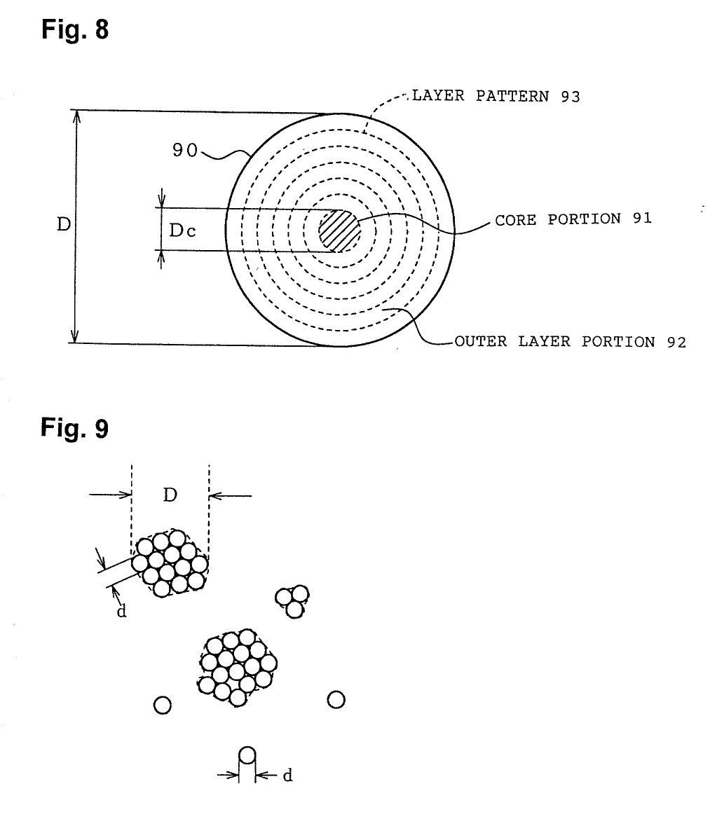

In order to accelerate the growth of the green body 80 during rolling granulation, as shown in FIG. 5, preferably, forming nuclei 50 are placed in the granulation container 132. While the forming nucleus 50 is rolling down the forming material powder layer 10k as shown in FIG. 7(a), the forming material powder 10 adheres to and aggregates on the forming nucleus 50 spherically, as shown in FIG. 7(b), to thereby form the spherical green body 80 (rolling granulation process). The green body 80 is sintered to thereby become an unfinished bearing ball 90 shown in FIG. 8.

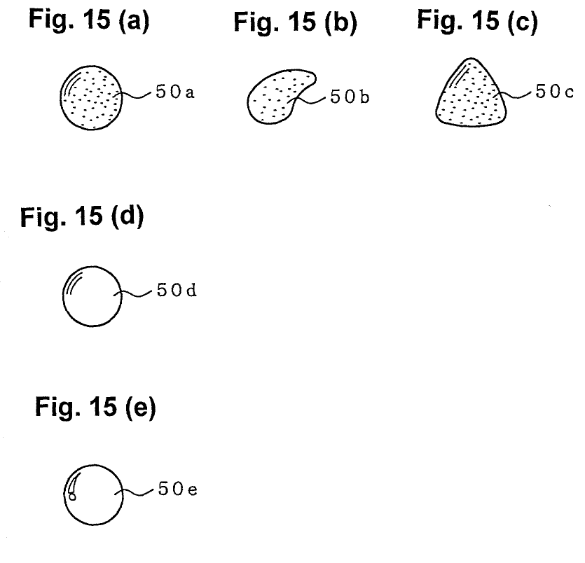

Preferably, the forming nucleus 50 is formed predominantly of ceramic powder as represented by a forming nucleus 50a shown in FIG. 15(a); for example, the forming nucleus 50 is formed of a material having composition similar to that of the forming material powder 10 (however, a ceramic powder different from the ceramic powder (inorganic material powder) constituting predominantly the forming material powder 10 may be used). This is because the nucleus 50a is unlikely to act as an impurity source on the finally obtained ceramic ball 90. However, when there is no possibility of a nucleus component difflusing to a surface layer portion of the ceramic ball 90, the nucleus 50 may be formed of a ceramic powder different from the ceramic powder (inorganic material powder) constituting predominantly the forming material powder 10; alternatively, the nucleus 50 may be a metal nucleus 50d shown in FIG. 15(d) or a glass nucleus 50e shown in FIG. 15(e). Also, the nucleus 50 may be formed of a material which disappears through thermal decomposition or evaporation during firing; for example, the nucleus 50 may be formed of a polymeric material, such as wax or resin. The forming nucleus 50 may assume a shape other than sphere, as shown in FIG. 15(b) or 15(c). Preferably, the forming nucleus 50 assumes a spherical shape, as shown in FIG. 15(a), in order to enhance the sphericity of a green body to be obtained.

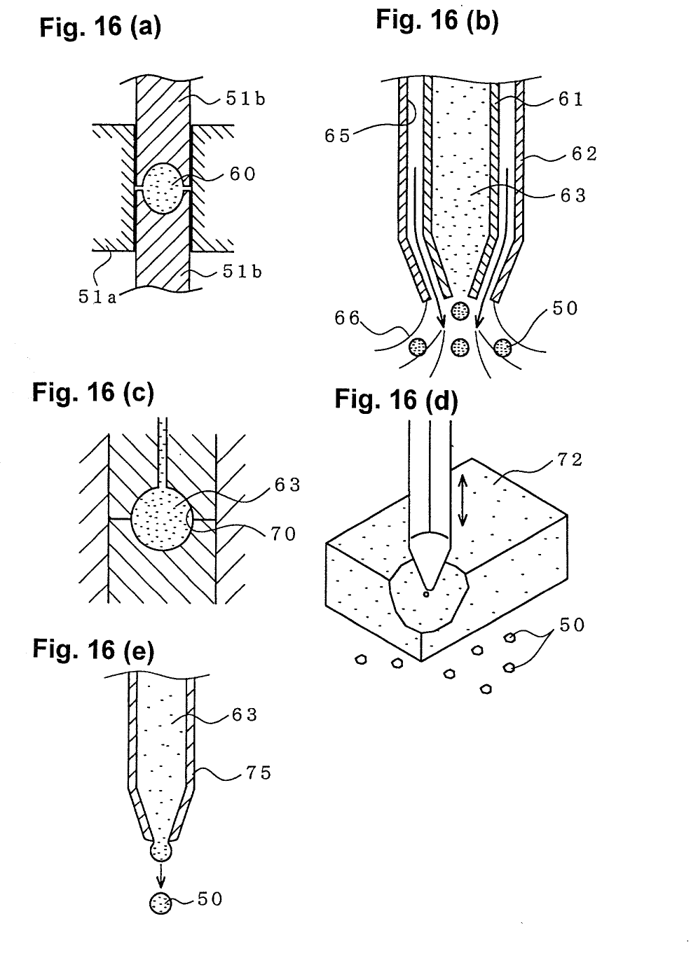

A method for manufacturing the forming nuclei 50 is not particularly limited. When the forming nuclei 50 are composed predominantly of ceramic powder, for example, various methods as shown in FIG. 16 can be employed. According to the method shown in FIG. 16(a), a ceramic powder 60 is compacted by means of a die 51a and press punches 51b (other compression means may be used instead), thereby obtaining the nucleus 50. According to the method shown in FIG. 16(b), ceramic powder is dispersed into a molten thermoplastic binder to obtain a molten compound 63, and the thus-obtained molten compound 63 is sprayed and solidified, thereby obtaining the nuclei 50. According to the method shown in FIG. 16(c), the molten compound 63 is injected into a spherical cavity formed in an injection mold, thereby molding the spherical nucleus 50. According to the method shown in FIG. 16(e), the molten compound 63 is caused to fall freely from a nozzle so as to assume a spherical shape by means of surface tension effect, and the thus-formed spherical droplet is cooled and solidified in the air to become the nucleus 50. Alternatively, slurry is formed from material powder, a monomer (or a prepolymer), and a dispersant solvent. The slurring is dispersed in a liquid which does not mix with the slurry, so as to assume the form of globules in the liquid. Then, the monomer or prepolymer is polymerized, thereby obtaining spherical bodies, which serve as the nucleus 50. Alternatively, the forming material powder 10 is singly placed in the granulation container 132, and the granulation container 132 is rotated at a speed lower than that for growing the green body 80 (see FIG. 6), so as to form powder aggregates. When powder aggregates of sufficiently large size are generated in a sufficient amount, the rotational speed of the aggregation container 132 is increased to thereby grow the green bodies 80 while utilizing the aggregates as the nuclei 50. In this case, there is no need to place the nuclei 50 manufactured in a separate process, in the granulation container 132 together with the forming material powder 10.

The thus-obtained forming nucleus 50 does not collapse and can stably maintain the shape even when some external force is imposed thereon. Thus, when the nucleus 50 rolls down the forming material powder layer 10k as shown in FIG. 7(a), the nucleus 50 can reliably sustain reaction induced from its own weight. Conceivably, since powder particles which are caught on the rolling nucleus 50 can be firmly pressed on the surface of the nucleus 50 as shown in FIG. 7(c), the powder particles are appropriately compressed to thereby grow into a highly dense aggregate layer 10a. By contrast, as shown in FIG. 7(d), when no nucleus is used, an aggregate 100 corresponding to a nucleus is formed merely on accidental basis. Also, since the aggregate 100 is rather loose and soft, during rolling down the forming material powder layer 10k, the aggregate 100 deforms, or, in the worst case, collapses, failing in many cases to induce adhesion and aggregation of powder particles. As a result, formation of a green body consumes much time, and a formed green body becomes highly likely to contain a defect, such as cracking and a pore formed as a result of bridging of particle powders.

The size of the nucleus 50 is at least approximately 40 μm (preferably, approximately 80 μm). When the nucleus 50 is too small, the growth of the aggregate layer 10a may become incomplete. When the nucleus 50 is too large, the thickness of the aggregate layer 10a to be formed becomes insufficient; as a result, a sintered body tends to suffer occurrence of defect. Preferably, the size of the nucleus 50 is, for example, not greater than 1 mm.

Preferably, the forming nucleus 50 assumes the form of an aggregate of ceramic powder having a density higher than the bulk density (for example, apparent density prescribed in JIS Z2504 (1979)) of the forming material powder 10. Such an aggregate of ceramic powder can reliably sustain the pressing force of powder particles to thereby accelerate the growth of the aggregate layer 10a. Specifically, an aggregate of ceramic powder having a density at least 1.5 times the bulk density of the forming material powder 10 is preferred. In this case, sufficient aggregation is such that, when an aggregate rolls down the forming material powder layer 10k, the aggregate does not collapse from the shock of rolling.

In order to grow the green body 80 more stably, preferably, the size of the nucleus 50 is determined according to the size of the green body 80 in the following manner. As shown in FIG. 7(b), the size of the forming nucleus 50 is represented by the diameter dc of a sphere having a volume equal to that of the nucleus 50 (when the nucleus 50 is spherical, the diameter thereof is the size in question), and the diameter of the finally obtained spherical green body 80 is represented by dg. The diameter dc is determined such that dc/dg is 1/100-1/2. When dc/dg is less than 1/100, the nucleus 50 becomes too small, potentially causing insufficient growth of the aggregate layer 10a or occurrence of many defects in the aggregate layer 10a. When dc/dg is in excess of 1/2, and the density of the nucleus 50 is not sufficiently high, the strength of a sintered body to be obtained may become insufficient. The ratio dc/dg is preferably 1/50-1/5, more preferably 1/20-1/10. The size dc of the forming nucleus 50 is preferably 20-200 times the average grain size of the forming material powder 10. Preferably, the absolute value of the size dc is, for example, 50-500 μm.

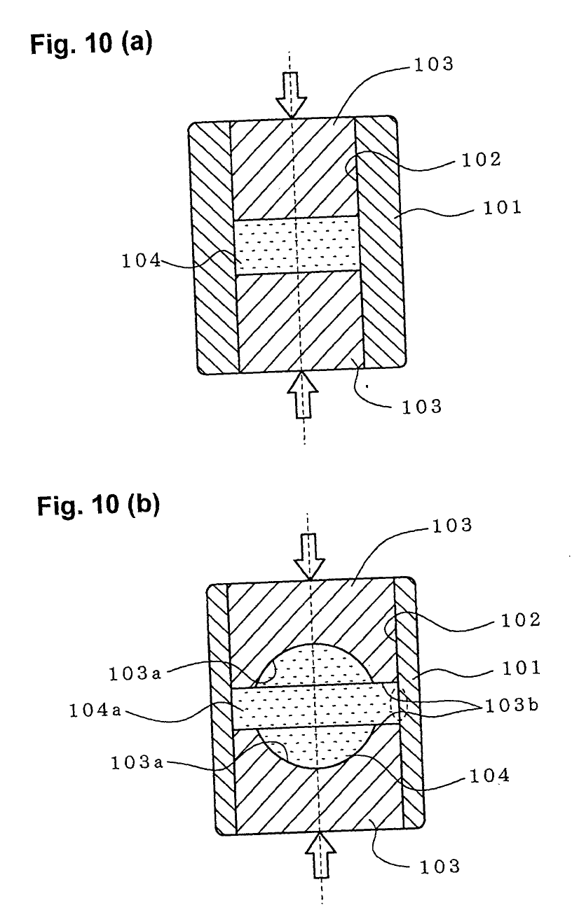

FIG. 10(b) shows a forming process other than the rolling granulation process. Upper and lower press punches 103 are inserted into a die hole 102 formed in a forming die 101. A hemispheric cavity 103a is formed on the end face of each of the upper and lower press punches 103. Powder is compressed between the upper and lower press punches 103, thereby yielding a spherical ceramic green body 104. Preferably, the punches 103 used in such a die pressing process are such that peripheral edge portions of the punching faces of the press punches 103 are flattened so as to increase the pressing pressure in these regions. However, this process involves formation of a flange-like unnecessary portion 104a, corresponding to the flattened portions 103b, on the green body 104. This unnecessary portion 104a must be removed through polishing before or after sintering. Alternatively, as shown in FIG. 10(a), a green pellet may be formed.

In manufacture of ceramic balls, in place of die pressing, cold isostatic pressing (CIP) may be employed. Specifically, a spherical preliminary green body is formed by, for example, the die pressing process described above. The preliminary green body is placed in a rubber tube in a sealed condition. Then, pressure is isostatically applied to the thus-prepared preliminary green body through application of hydrostatic pressure by means of medium for spherical formation, such as oil or water. When the density of a green body is not sufficiently enhanced after a single practice of cold isostatic pressing, cold isostatic pressing may be repeatedly carried out; i.e., a cyclic CIP process may be employed.

The following method other than the die pressing process can also be employed. A forming material powder is dispersed in a thermoplastic binder to thereby form a slurry. This slurry is subjected to free fall from a nozzle. While assuming the form of a sphere by the action of surface tension, each droplet of the slurry is cooled and solidified in the air (as disclosed in, for example, Japanese Patent Application Laid-Open (kokai) No. 229137/1988). Alternatively, a forming material powder, a monomer (or prepolymer), and a dispersion solvent are mixed so as to obtain a slurry. This slurry is dispersed in the form of droplets in a liquid which does not blend with the slurry. In this dispersed state, the monomer or prepolymer is polymerized, thereby obtaining spherical green bodies (as disclosed in, for example, Japanese Patent Application Laid-Open (kokai) No. 52712/1996).

The thus-obtained green body is fired in the following manner to thereby become the silicon nitride sintered body of the present invention. Firing is performed in an atmosphere containing at least nitrogen at a gas pressure of 10-200 atm. When the gas pressure is less than 5 atm, sufficient strength is not imparted to a sintered body. When the gas pressure is in excess of 1000 atm, the surface hardness of a sintered body increases, causing difficulty in machining the surface of the sintered body. Preferably, the firing temperature is 1500-1800° C. When the firing temperature is lower than 1500° C., the a silicon nitride phase becomes likely to be formed, resulting in impaired machinability. When the firing temperature is in excess of 1800° C., grain growth causes impairment in the strength of a sintered body. Preferably, firing is maintained for 1-5 hours. When the firing retention time is not longer than 1 hour, differences in characteristics among sintered bodies increase, causing difficulty in adjusting the grain aspect ratio α to an appropriate range. When the firing retention time becomes 10 hours or longer, the density of a silicon nitride sintered body becomes too high, causing unusual grain growth. As a result, the average grain size dav fails to fall within the range of 0.5-5.0 μm. Notably, firing can be performed in two stages; i.e., primary firing and secondary firing. For example, primary firing is performed so as to attain a relative density of not lower than 74%, preferably not lower than 80%, as measured after primary firing, followed by secondary firing. When the relative density of a sintered body after primary firing is lower than 70%, the sintered body tend to suffer a number of defects, such as pores, remaining therein after secondary firing.

Preferably, primary firing is performed in such a manner as to retain firing at a temperature of 1400-1700° C. for 2-5 hours in a nonoxidizing atmosphere containing nitrogen and having a pressure of 1-10 atm. Firing under the above conditions produces a sintered body having the above-mentioned relative density. Preferably, secondary firing is performed in such a manner as to retain firing at a temperature of 1500-1800° C. for 2-5 hours in a nonoxidizing atmosphere containing nitrogen and having a pressure of 50-200 atm. Through employment of two-stage firing to be performed under the above conditions, defects, such as pores, become unlikely to remain in an obtained sintered body, and the sintered body balances surface hardness and wearability with machinability.

The unfinished ball 90 obtained through firing of the spherical green body 80 which, in turn, is obtained by means of the rolling granulation process has the structure shown in FIG. 8, which is an enlarged schematic view showing a polished cross section taken substantially across the center of the ball 90. Specifically, a core portion 91 derived from the forming nucleus is formed at a central portion of the unfinished ball 90 distinguishably from an outer layer portion 92, which is derived from the aggregate layer and features high density and few defects. In many cases, the core portion 91 exhibits a visually distinguishable contrast with the outer layer portion 92 with respect to at least brightness or color tone. Conceivably, such contrast is exhibited because of difference between ceramic density ρe of the outer layer portion 92 and ceramic density ρc of the core portion 91. For example, when the forming nucleus 50 (FIG. 7) is lower in density than the aggregate layer 10a, the ceramic density ρe of the outer layer portion 92 becomes higher than the ceramic density ρc of the core portion 91 in many cases. As a result, the color tone of the outer layer portion 92 becomes brighter than that of the core portion 91. In view of attainment of appropriate strength and durability of ceramic, the relative density of the outer layer portion 92 is not lower than 99%, preferably not lower than 99.5%. In any case, through attainment of a sintered-body structure that the above-mentioned structural feature appears on a polished cross section, there can be realized a spherical ceramic sintered-body featuring high density, high strength, and low fraction defective (for example, to such an extent that no pore is observed) at the surface layer portion 92, which is a key to enhancement of performance of, for example, a bearing. In the case where firing has proceeded uniformly, a resultant sintered body may exhibit substantially uniform density in a radial direction from a surface layer portion to a central portion. Alternatively, even when the core portion and the outer layer portion differ in color tone or lightness, almost no difference may exist in density therebetween. In the case where firing has proceeded in a highly uniform manner, concentric contrast patterns may not be visually observed at the core portion 91 or at the outer layer portion 92.

When dc/dg is adjusted to 1/100-1/2 (preferably 1/50-1/5, more preferably 1/20-1/5), where, as shown in FIG. 7(b), dc is the diameter of the forming nucleus 50, and dg is the diameter of an unfinished ball obtained through firing, the cross section of the sintered body 90 shown in FIG. 8 assumes a structure such that Dc/Dg is 1/100-1/2 (preferably 1/50-1/5, more preferably 1/20-1/10), where Dc is the diameter of a circle having an area equal to that of the core portion 91 (when the nucleus 50 is formed of a material which disappears through thermal decomposition or evaporation during firing; for example, wax, resin, or like polymeric material, the core portion 91 becomes a void portion), and Dg is the diameter of the ceramic sintered-body. When Dc/Dg is less than 1/50, the aggregate layer l0a (FIG. 7), which becomes the outer layer portion 92, tends to suffer occurrence of defects, potentially resulting in insufficient strength. When Dc/Dg is in excess of 1/5, and, for example, the density of the nucleus 50 is not very high, the strength of the sintered body may become insufficient. Dc/Dg is preferably 1/20-1/10.

An example of visually distinguishable contrast between the core portion 91 and the outer layer portion 92 in the unfinished ball 90 is the state in which brightness or color tone differs in the radial direction of the ball 90 while being unchanged in the circumferential direction. Specifically, a concentric layer pattern is formed in the outer layer portion 92 in such a manner as to surround the core portion 91 as observed on the polished cross section of the unfinished ball 90. This is a typical structural feature (which is applied to a polished ceramic ball accordingly) as observed in employment of the rolling granulation process. Conceivably, the structural feature arises for the following reason. As shown in FIG. 7(a), while the green body 80 is rolling down the forming material powder layer 10k, the aggregate layer 10a grows. However, during rolling granulation, the green body 80 is not always present on the forming material powder layer 10k. That is, as shown in FIG. 7, since the forming material powder 10 slides like avalanche as the granulation container 132 rotates, the green body 80 which has reached the lower end portion of the slope of the forming material powder layer 10k is caught into the forming material powder layer 10k. Then, the green body 80 is brought up along the wall surface of the granulation container 132 to an upper end portion of the slope of the forming material powder layer 10k. The green body 80 again rolls down the forming material powder layer 10k. When the green body 80 is caught in the forming material powder layer 10k, the green body 80 is pressed by the surrounding forming material powder 10, and is thus less susceptible to impact associated with a rolling-down motion. As a result, powder particles adhere to the green body 80 in a relatively loose manner. By contrast, when the green body 80 rolls down the forming material powder layer 10k, the green body 80 is subjected to impact associated with a rolling-down motion and is susceptible to the spray of liquid spray medium W, such as water. As a result, powder particles adhere to the green body 80 in a relatively tight manner. Since the green body 80 rolls down and is caught into the forming material powder layer 10k cyclically, the state of adhesion of powder varies cyclically. Accordingly, the aggregate layer 10a, which is formed of adhering powder particles, involves repetitions of condensation and rarefaction in the radial direction. Even after sintering, the repetitions of condensation and rarefaction emerge in the form of delicate difference in density, thereby forming a layer pattern 93 (when the difference between condensation and rarefaction is very small, the actual occurrence of condensation and rarefaction may not be observed by means of ordinary density measurement, since the precision of the measurement is not sufficiently high). Conceivably, for example, the layer pattern 93 is composed of concentric spherical portions of different densities, which are alternately arranged in layers.

The surface of the thus-obtained silicon nitride ceramic ball undergoes precision polishing, to thereby yield a bearing ball. The silicon nitride ceramic of the silicon nitride ceramic ball is such that p silicon nitride crystal grains make up a predominant portion of the silicon nitride phase crystal grains in the microstructure thereof and such that crystal grains each having an aspect ratio α of 1-5 are present in the aforementioned quantity per unit area. Thus, machining of the silicon nitride ceramic ball for obtaining a bearing ball can be performed efficiently. The thus-obtained silicon nitride bearing ball exhibits excellent wear resistance and thus can be effectively used in a working condition of high-speed rotation at room temperature, as in a hard disk drive or a polygon scanner.

As shown in FIG. 12, ceramic balls 43 obtained as above are incorporated between an inner ring 42 and an outer ring 41, which are made of, for example, metal or ceramic, thereby yielding a radial ball bearing 40. When a shaft SH is fixedly attached to the internal surface of the inner ring 42 of the ball bearing 40, the ceramic balls 43 are supported rotatably or slidably with respect to the outer ring 41 or the inner ring 42.

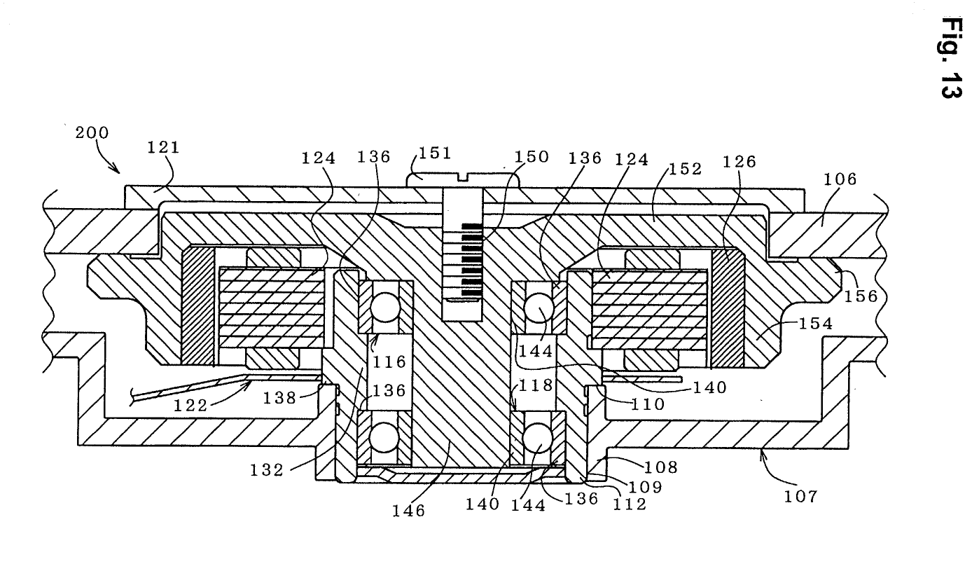

FIG. 13 is a longitudinal sectional view showing an example of configuration of a hard disk drive using the above-mentioned ball bearing. The hard disk drive 100 includes a body casing 107; a cylindrical shaft holder portion 108 formed at the center of the bottom of the body casing 107 in a vertically standing condition; and a cylindrical bearing holder bush 112 coaxially fitted to the shaft holder portion 108. The bearing holder bush 112 has bush fixation flanges 110 and 138 formed on the outer circumferential surface thereof and is axially positioned while the bush fixation flanges 110 and 138 abuts one end of the shaft holder portion 108. Ball bearings 116 and 118 of the present invention configured in the same manner as shown in FIG. 12 are coaxially fitted into the bearing holder bush 112 at the corresponding opposite end portions of the bush 112 while abutting the corresponding opposite ends of a bearing fixation flange 132 projecting inward from the inner wall of the bearing holder bush 112 to thereby be positioned. The ball bearings 116 and 118 are configured such that a plurality of ceramic balls 144 of the present invention are disposed between an inner ring 140 and an outer ring 136.

A disk-rotating shaft 146 is fixedly fitted into the inner rings 140 of the ball bearings 116 and 118 to thereby be supported by the ball bearings 116 and 118 in a rotatable condition with respect to the bearing holder bush 112 and the body casing 107. A flat, cylindrical disk fixation member (rotational member) 152 is integrally formed at one end of the disk-rotating shaft 146. A wall portion 154 is formed along the outer circumferential edge of the disk fixation member in a downward extending condition. An exciter permanent-magnet 126 is attached to the inner circumferential surface of the wall portion 154. A coil 124 fixedly attached to the outer circumferential surface of the bearing holder bush 112 is disposed within the exciter permanent-magnet 126 in such a manner as to face the exciter permanent-magnet 126. The coil 124 and the exciter permanent-magnet 126 constitute a DC motor 122 for rotating the disk. The motor 122 and the bearings 116 and 118 constitute a motor having a bearing of the present invention while the disk-rotating shaft 146 serves as an output shaft. The maximal rotational speed of the motor 122 is not lower than 8000 rpm. When a higher access speed is required, the maximal rotational speed reaches 10000 rpm or higher, and, in a certain case, 30000 rpm or higher. The number of turns of the coil 124, the intensity of external magnetic field generated by the exciter permanent-magnet 126, a rated drive voltage, and a like design factor are determined appropriately in consideration of load for rotating the disk, so as to implement the above-mentioned maximal rotational speed. A disk fixation flange 156 projects outward from the outer circumferential surface of the wall portion 154 of the disk fixation member 152. An inner circumferential edge portion of a recording hard disk 106 is fixedly held between the disk fixation flange 156 and a presser plate 121. A clamp bolt 151 is screwed into the disk-rotating shaft 146 while extending through the presser plate 121.

When the coil 124 is energized, the motor 122 starts rotating to thereby generate a rotational drive force while the disk fixation member 152 serves as a rotor. As a result, the hard disk 106 fixedly held by the disk fixation member 152 is rotated about the axis of the disk-rotating shaft 146 supported by the bearings 116 and 118.

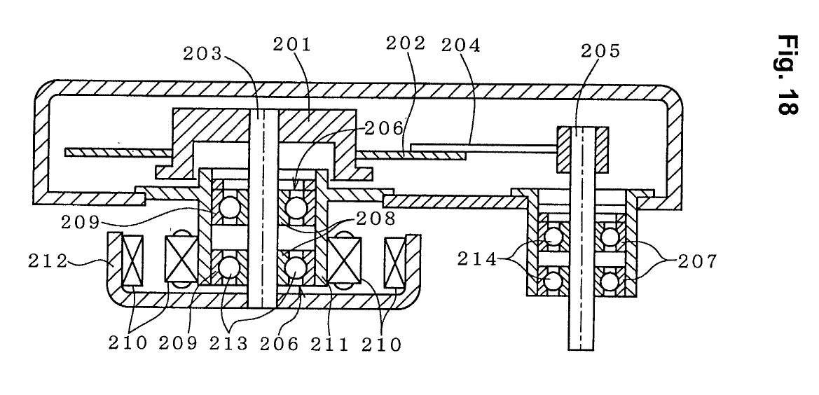

FIG. 18 shows the structure of a hard disk drive (hereinafter abbreviated to HDD) including a head arm drive unit. The structure has two rotational shafts; i.e., a rotational shaft 203 for rotationally supporting a magnetic disk 202 via a hub 201 and a rotational shaft 205 for a head arm 204 having a magnetic head (not shown) attached to its end. The rotational shaft 203 is supported by two ball bearings 206 of the present invention disposed axially apart from each other by a certain distance, whereas the rotational shaft 205 is supported by two ball bearings 207 of the present invention disposed axially apart from each other by a certain distance. The ball bearings 206 and 207 assume the same structure as that described previously. Inner rings 208 of the paired ball bearings 206 are fixedly attached to the rotational shaft 203 so as to rotate unitarily with the rotational shaft 203. Outer rings 209 of the paired ball bearings 206 are fixedly fitted into a cylindrical stator 211 of a spindle motor 210 (the spindle motor 210 and the bearings 206 constitute a motor having a bearing of the present invention, while the rotational shaft 203 serves as an output shaft of the motor). The rotational shaft 203 is located at the center of a dish-type rotor 212 and is rotated by means of the spindle motor 210.

The magnetic disk 202, which is rotatably supported as described above, rotates at high speed according to the rotational speed of the spindle motor 210. During rotation of the magnetic disk 202, the head arm 204, to which a magnetic head for reading/writing magnetic recording data is attached, operates as appropriate. The base end of the head arm 204 is supported by an upper portion of the rotational shaft 205. The rotational shaft 205 is rotated about its axis by means of an unillustrated actuator including a VCM such that the distal end of the head arm 204 is rotated by a required angle to thereby move the magnetic head to a required position. Thus, through rotational movement of the rotational shaft 205, required magnetic recording data can be read from or written to an effective recording region of the magnetic disk 202.

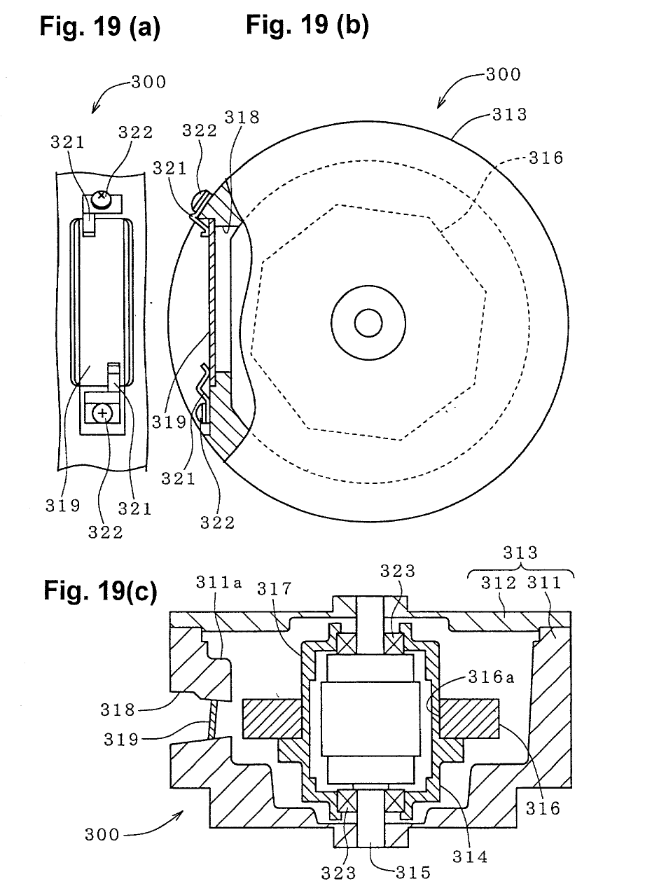

FIG. 19 shows an embodiment of a polygon scanner using the above-described ball bearing (FIG. 19(a) is a front view, FIG. 19(b) is a plan view, and FIG. 19(c) is a longitudinal sectional view). A polygon scanner 300 is used to generate a scanning light beam in image processing, such as photographing and copying, as well as in a laser printer. A motor 314 (herein, an outer rotor type), which serves as a motor having a bearing of the present invention, is accommodated within a substantially cylindrical enclosed case 313 composed of a body 311 and a cover 312 for covering the body 311. Opposite ends of a stationary shaft 315 are fixedly attached to the body 311 and the cover 312, respectively. A polygon mirror 316 includes a polygonal platelike member and reflectors formed on corresponding side walls of the polygonal platelike member. In the present embodiment, the polygon mirror 316 assumes the shape of a regular octagon. A rotor 317 of the motor 314 is fixedly inserted into a mounting hole 316a formed at a central portion of the polygon mirror 316, whereby the rotor 317 and the polygon mirror 316 can rotate unitarily. The rotor 317 is rotatably supported by the stationary shaft 315 via two ball bearings 323 of the present invention. The ball bearings 323 assume a structure similar to that shown in FIG. 12. The motor 314 rotates at high speed; for example, at a maximal rotational speed of not lower than 10000 rpm or 30000 rpm.

A window 318 for allowing an incoming/outgoing light beam to pass through is formed on the side wall of the body 311 in opposition to the polygon mirror 316. A window glass 319 is attached to the window 318. The window glass 319 is fitted to the window 318 from outside and is then pressed in place by means of a pair of flat springs 321. In FIG. 22, reference numeral 322 denotes a mounting screw for fixing the other end of the flat spring 321 on the body 311. A protrusion 311a is formed on the inner wall of the body 311 so as to provide a seat for the window glass 319.

When the motor 314 is operated, the polygon mirror 316 rotates about the axis of the stationary shaft 315. A light beam, such as a laser beam, entering through the window 318 impinges on the rotating polygon mirror 316 along a predetermined direction. Reflectors on the side walls of the rotating polygon mirror 316 sequentially reflect the incident light beam. The thus-reflected light beams are emitted through the window 318 and serve as scanning light beams.

### EXAMPLE

In order to examine the effects of the present invention, the following experiment was carried out. A silicon nitride powder (silicon nitride purity: 98% by weight; α phase percentage: 90%; average grain size: 0.5 μm; and BET specific surface area: 10 m²/g) was prepared as a material powder. An yttria powder (average grain size: 0.6 μm; and BET specific surface area: 10 m²/g) and an alumina powder (average grain size: 0.4 μm; and BET specific surface area: 10 m²/g) were prepared as sintering aid components. The average grain size was measured by use of a laser diffraction granulometer (model LA-500, product of Horiba, Ltd.). The BET specific surface area was measured by use of a BET-specific-area measuring device (MULTISORB 12, product of Yuasa Ionics, Corp.).

The above-mentioned material powders were mixed according to the following composition: silicon nitride powder 100 parts by weight; yttria powder 5 parts by weight; and alumina powder 5 parts by weight. The resulting mixture was subjected to rolling granulation, thereby yielding green bodies. In the present experiment, green bodies for silicon nitride sintered bodies were each formed into a spherical shape. The thus-obtained green bodies were fired into silicon nitride balls.

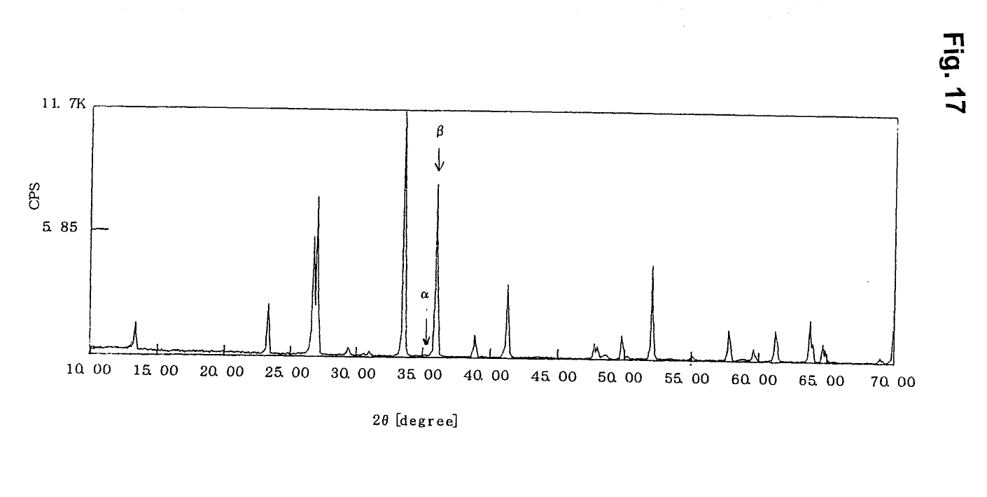

The obtained silicon nitride balls were each measured for an X-ray diffraction profile on a cross section thereof by use of a diffractometer. The peak intensity Xα associated with α silicon nitride and the peak intensity Xβ associated with β silicon nitride were obtained from the profile. The value of Xβ/(Xα+Xβ) was obtained from the measured values. FIG. 17 shows the measured X-ray diffraction profile of Sample No. 2.

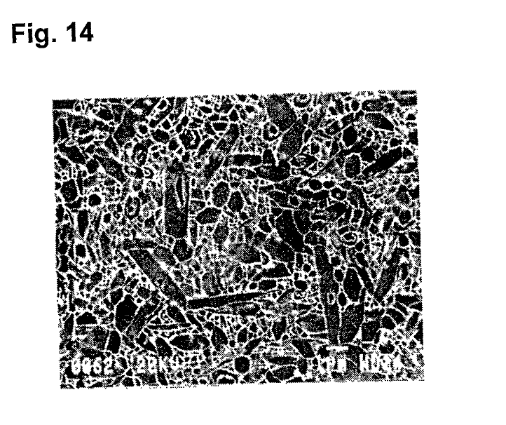

The cross section of each silicon nitride ball sample was observed by means of a scanning electron microscope (SEM; 5000 magnifications). An example of an obtained observation image is shown in FIG. 14. Silicon nitride phase crystal grains observed on the image were measured for the average grain size dav and the grain aspect ratio α as defined previously. The number of silicon nitride phase crystal grains each having a dav value of 0.5-5.0 μm and an α value of 1-5 were counted and converted to that per a unit field area of 1 mm². Notably, a single field of observation measures 50 μm×50 μm. For each sample, the number of crystal grains was counted in 5 fields of observation. The obtained five counted values were averaged to thereby obtain the number of crystal grains for the sample.

The thus-obtained sintered bodies of the present invention were surface-polished by means of a wet precision polishing machine using a grooved surface-plate grindstone (abrasive No.: #20000), thereby yielding silicon nitride balls. The obtained silicon nitride balls were measured for sphericity to thereby examine machinability thereof. Machinability was evaluated according to the following criteria: sphericity less than 0.05 μm: good (∘); sphericity 0.05-0.08 μm: acceptable (Δ); and sphericity in excess of 0.08 μm: poor (X). Sphericity was measured by use of TARYLOND 73P, a product of Hobson Corp. and a known profile measuring machine. For comparison, silicon nitride ceramic balls falling outside the scope of the invention were also examined in a similar manner. The results are shown in Table 1.

TABLE 1

| | | |
|---|---|---|
| Primary Firing | Secondary Firing | Number of Grains |

| | | Retention | | Retention | Pressure of | Peak Intensity | dav = 0.5 − 5.0 μm | |
|---|---|---|---|---|---|---|---|---|
| Sample | Firing Temp. | Time | Firing Temp. | Time | Atmosphere | Ratio | α = 1 − 5 | Machin- |
| No. | (° C.) | (h) | (° C.) | (h) | (atm) | Xβ/(Xα + Xβ) | [grains/mm²] | ability |
| 1 | 1500 | 2 | 1700 | 2 | 80 | 0.95 | 5.6 × 10⁴ | ∘ |
| 2 | 1500 | 2 | 1700 | 2 | 1000 | 0.98 | 5.1 × 10⁴ | ∘ |
| 3 | 1600 | 2 | 1700 | 2 | 1000 | 1 | 4.4 × 10⁴ | ∘ |
| 4 | 1700 | 2 | 1700 | 2 | 80 | 1 | 3.8 × 10⁴ | ∘ |
| 5* | 1700 | 2 | 1450* | 2 | 1000 | 0.8* | 4.7 × 10⁴ | X |
| 6* | 1400 | 2 | 1450* | 2 | 1000 | 0.7* | 5.5 × 10⁴ | X |
| 7* | 1600 | 5 | 1750 | 10* | 80 | 1 | 1.2 × 10⁴ | X |
| 8* | 1700 | 5 | 1750 | 10* | 80 | 1 | 8.7 × 10³ | X |

Samples marked with * fall outside the scope of the invention.

What is claimed is:

1. A silicon nitride sintered body whose predominant crystalline phase is a silicon nitride phase, wherein
an X-ray diffraction profile measured on a cross section of said body by means of a diffractometer is such that Xβ/(Xα+Xβ) is 0.9−1, wherein Xα is a peak intensity associated with α silicon nitride phase and Xβ is a peak intensity associated with β silicon nitride phase, and
silicon nitride phase crystal grains of said body have an average grain size dav represented by (dmax+dmin)/2 of 0.5-5.0 μm and a grain aspect ratio α represented by dmax/dmin of 1-5, and are present in an average number of not less than 2×10⁴ per square millimeter at least in a region on the cross section ranging from a surface of the sintered body to a depth of 0.5 mm, wherein dmax is a distance between parallel lines circumscribing an outline of an observed silicon nitride phase crystal grain and whose distance is the greatest among such circumscribing parallel lines, and dmin is a distance between parallel lines circumscribing the outline of the observed silicon nitride phase crystal grain and whose distance is the shortest among such circumscribing parallel lines.

2. A silicon nitride ball whose predominant crystalline phase is a silicon nitride phase, wherein
an X-ray diffraction profile measured on a cross section taken substantially across a center of the ball by means of a diffractometer is such that Xβ/(Xα+Xβ) is 0.9−1, wherein Xα is a peak intensity associated with a silicon nitride phase and Xβ is a peak intensity associated with β silicon nitride phase, and
silicon nitride phase crystal grains of said ball have an average grain size dav represented by (dmax+dmin)/2 of 0.5-5.0 μm and a grain aspect ratio α represented by dmax/dmin of 1-5, and are present in an average number of not less than 2×10⁴ per square millimeter at least in a region on the cross section ranging from a surface of the sintered body to a depth of 0.5 mm, wherein dmax is a distance between parallel lines circumscribing an outline of an observed silicon nitride phase crystal grain and whose distance is the greatest among such circumscribing parallel lines, and dmin is a distance between parallel lines circumscribing the outline of the observed silicon nitride phase crystal grain and whose distance is the shortest among such circumscribing parallel lines.

3. A silicon nitride bearing ball comprising a silicon nitride ball as in claim 2 forming a rolling element of a bearing.

4. A ball bearing comprising a plurality of silicon nitride bearing balls as in claim 3 incorporated therein as rolling elements.

5. A ball bearing as in claim 4, incorporated in a hard disk drive as a bearing member for a shaft for rotating a hard disk or as a bearing member for a rotary shaft for driving a head arm.

6. A motor having a bearing comprising a ball bearing as in claim 4 or 5 incorporated as a bearing member.

7. A motor having a bearing as incorporated in claim 6, incorporated in a drive unit of a hard disk drive for rotating a hard disk.

8. A motor having a bearing as incorporated in claim 6, incorporated in a drive unit of a polygon scanner for driving a polygon mirror.

9. A motor having a bearing as in claim 6, wherein said motor rotates at a maximal speed of not less than 8000 rpm.

10. A hard disk drive comprising a motor having a bearing as in claim 7 and a hard disk to be rotatable by said motor.

11. A polygon scanner comprising a motor having a bearing as in claim 8 and a polygon mirror rotatatable by said motor.

12. A hard disk drive comprising a motor having a bearing as in claim 9 and a hard disk to be rotatable by said motor.

13. A polygon scanner comprising a motor having a bearing as in claim 9 and a polygon mirror rotatatable by said motor.
